(19) United States
(12) Patent Application Publication
(10) Pub. No.: US 2022/0263264 A1
(43) Pub. Date: Aug. 18, 2022

(54) COMMUNICATION CABLE WITH CONNECTOR AND CONNECTOR ASSEMBLY

(71) Applicant: SUMITOMO WIRING SYSTEMS, LTD., Mie (JP)

(72) Inventors: Takuma HIBINO, Mie (JP); Harald LUTSCH, Wolfsburg (DE)

(21) Appl. No.: 17/603,841

(22) PCT Filed: Apr. 16, 2020
(86) PCT No.: PCT/JP2020/016802

§ 371 Date: Oct. 14, 2021

(30) Foreign Application Priority Data
Apr. 17, 2019 (JP) 2019-078761

(51) Int. Cl. H01R 13/52; H01R 13/516; H01R 13/6463; H01R 13/6588

(52) U.S. Cl. CPC H01R 13/52; H01R 13/6588; H01R 13/6463; H01R 13/516

(57) ABSTRACT

A communication cable with connector includes a first terminal, a connector member, a communication cable, a tubular conductive rubber member arranged on the outer periphery of a shielding layer exposed from a sheath in an end part of the communication cable, and a tubular water stop plug provided near the conductive rubber member. The water stop plug includes a cable hole through which the communication cable is inserted, and the cable hole includes a small-diameter portion to be held in close contact with the shielding layer and a large-diameter portion to be held in close contact with the sheath. An end surface of the sheath is caught by a step between the small-diameter portion and the large-diameter portion.

### TECHNICAL FIELD

The present disclosure relates to a communication cable with connector and a connector assembly.

This application claims a priority based on Japanese Patent Application No. 2019-078761 filed on Apr. 17, 2019, the contents of which are hereby incorporated by reference.

### BACKGROUND

In recent years, high communication of e.g. 100 Mbps or faster has been required. A communication cable with connector used in such high-speed communication is disclosed, for example, in Patent Document 1 and the like. The communication cable with connector of Patent Document 1 includes a communication cable having a conductor and a shield terminal (connector module) to be mounted on an end part of the communication cable. The shield terminal includes a terminal unit and an outer conductor (shield member) for shielding electromagnetic waves. The terminal unit includes an inner conductor (first terminal) functioning as a terminal and a dielectric (connector portion) made of synthetic resin and functioning as a connector.

The communication cable with connector of Patent Document 1 is a communication cable with connector of a waterproof type. In the configuration of Patent Document 1, the shield terminal is accommodated in a first housing made of synthetic resin. A water stop plug is fit in a rear end part (end part on the side of the communication cable) of the first housing. The water stop plug is fit on the outer periphery of a sheath in the communication cable. The water stop plug is normally fixed to the first housing by a holder.

### PRIOR ART DOCUMENT

### Patent Document

Patent Document 1: JP 2018-152174 A

### SUMMARY OF THE INVENTION

### Problems to be Solved

A communication cable with connector of the present disclosure is a communication cable with connector used in communication of 100 Mbps or faster and includes a first terminal, a connector member made of resin for accommodating the first terminal, a tubular shield member for covering an outer periphery of the connector member, a communication cable including a conductor to be electrically connected to the first terminal, a shielding layer arranged on an outer peripheral side of the conductor and a sheath for covering an outer periphery of the shielding layer, a tubular conductive rubber member for electrically connecting the shielding layer exposed from the sheath in an end part of the communication cable and the shield member, and a tubular water stop plug provided near the conductive rubber member, wherein the water stop plug includes a cable hole, the communication cable being inserted through the cable hole, the cable hole including a small-diameter portion to be held in close contact with the shielding layer and a large-diameter portion to be held in close contact with the sheath, and an end surface of the sheath is caught by a step between the small-diameter portion and the large-diameter portion.

A connector assembly of the present disclosure includes the communication cable with connector of the present disclosure, a signal cable including an inner housing having a plurality of second terminals, and an outer housing for accommodating the connector member and the inner housing.

### BRIEF DESCRIPTION OF THE DRAWINGS

FIG. 1 is a perspective view of a communication cable with connector of a first embodiment.

FIG. 2 is an exploded perspective view of the communication cable with connector of the first embodiment.

FIG. 3 is an exploded perspective view of a connector member provided in the communication cable with connector of the first embodiment.

FIG. 4 is a section along IV-IV of FIG. 1.

FIG. 5 is a section along V-V of FIG. 1.

FIG. 6 is a perspective view of a shield member shown in the first embodiment.

FIG. 7 is a perspective view of the shield member of FIG. 6 viewed from an opposite side.

FIG. 8 is a perspective view of a housing provided in the connector member shown in the first embodiment.

FIG. 9 is a perspective view of the housing of FIG. 8 viewed from an opposite side.

FIG. 10 is a perspective view of a cover provided in the connector member shown in the first embodiment.

FIG. 11 is a perspective view of the cover of FIG. 10 viewed from an opposite side.

FIG. 12 is a transverse section of the communication cable with connector shown in the first embodiment.

FIG. 13 is a perspective view of a first terminal provided in the communication cable with connector shown in the first embodiment.

FIG. 14 is a perspective view of the first terminal of FIG. 13 viewed from an opposite side.

FIG. 15 is a perspective view of a housing shown in a first modification.

FIG. 16 is a perspective view of a cover shown in the first modification.

FIG. 17 is a transverse section of a communication cable with connector shown in the first modification.

FIG. 18 is a schematic configuration diagram of a connector assembly of an embodiment.

### DETAILED DESCRIPTION TO EXECUTE THE INVENTION

### Problem the Invention Seeks to Solve

With the development of communication technologies of recent years, the number of communication cables with connector to be installed, for example, in automotive vehicles tends to increase. Thus, there is a need for making a configuration near a connector member in a communication cable with connector compact. There is also a need for improving the productivity of the communication cable with connector.

Accordingly, one object of the present disclosure is to provide a communication cable with connector having a compact configuration near a connector member and excellent in productivity. Another object of the present disclosure is to provide a connector assembly provided with the above communication cable with connector.

### Effect of Present Disclosure

The communication cable with connector and the connector assembly of the present disclosure have a compact configuration near a connector member and are excellent in productivity.

### DESCRIPTION OF EMBODIMENTS OF PRESENT DISCLOSURE

First, embodiments of the present disclosure are listed and described.

<1> A communication cable with connector according to an embodiment is a communication cable with connector used in communication of 100 Mbps or faster and includes a first terminal, a connector member made of resin for accommodating the first terminal, a tubular shield member for covering an outer periphery of the connector member, a communication cable including a conductor to be electrically connected to the first terminal, a shielding layer arranged on an outer peripheral side of the conductor and a sheath for covering an outer periphery of the shielding layer, a tubular conductive rubber member for electrically connecting the shielding layer exposed from the sheath in an end part of the communication cable and the shield member, and a tubular water stop plug provided near the conductive rubber member, wherein the water stop plug includes a cable hole, the communication cable being inserted through the cable hole, the cable hole including a small-diameter portion to be held in close contact with the shielding layer and a large-diameter portion to be held in close contact with the sheath, and an end surface of the sheath is caught by a step between the small-diameter portion and the large-diameter portion.

The conductive rubber member provided in the communication cable with connector according to the embodiment electrically connects the shielding layer of the communication cable, in which an induced current flows, and the shield member to be grounded. Thus, the induced current flowing in the shielding layer can be released to ground by the conductive rubber member.

Due to resilience, the conductive rubber member is easily arranged on the outer periphery of the shielding layer of the communication cable. This is because the conductive rubber member can be arranged on the outer periphery of the shielding layer only by fitting the conductive rubber member expanded in diameter to the communication cable. Thus, the communication cable with connector using the conductive rubber member is excellent in productivity. Further, due to resilience, the conductive rubber member is easily held in close contact with the outer periphery of the shielding layer. Therefore, in the communication cable with connector using the conductive rubber member, electrical connection between the shielding layer and the shield member is reliably ensured.

The water stop plug provided in the communication cable with connector according to the embodiment is structured to be directly mounted on the communication cable. Thus, the communication cable with connector according to the embodiment is excellent in productivity since a holder for fixing the water stop plug is not separately required.

Further, the water stop plug of the communication cable with connector according to the embodiment is arranged at a position straddling the shielding layer and the sheath. Thus, the communication cable with connector according to the embodiment is compact as compared to a conventional configuration in which a water stop plug is provided on the outer periphery of a sheath.

<2> As one form of the communication cable with connector according to the embodiment, the conductive rubber member and the water stop plug are integrated.

With a configuration in which a conductive rubber member and a water stop plug are integrated, the number of components constituting a communication cable with connector is reduced. Therefore, the communication cable with connector having the above configuration is excellent in productivity.

<3> As one form of the communication cable with connector according to the embodiment, the shield member is a cast body.

The outer conductor (shield member) in Patent Document 1 is configured by combining a first shell and a second shell obtained by press-molding a plate material. The first and second shells formed of press-molded bodies of the plate material are formed with a claw-like lock projection and a lock hole to be engaged with each other. To form the lock projection and the lock hole by press molding, the plate material has to be punched out. Thus, a hole, which becomes a path of electromagnetic waves, is formed in the peripheral surface of the outer conductor. The shield member formed of the cast body has the following advantages against such a conventional shield member.

The shield member formed of the cast body for covering around the first terminal via the connector member can be fabricated to have no hole open in the peripheral surface thereof. Thus, the communication cable with connector of the embodiment provided with the shield member formed of the cast body is excellent in electromagnetic wave shielding performance.

The shield member formed of the cast body is easily mountable on the connector member. This is because the shield member formed of the cast body needs not have a split structure. Thus, the communication cable with connector of this embodiment provided with the shield member formed of the cast body is excellent in productivity.

The shield member formed of the cast body can be accurately mounted on the connector member. This is because it is sufficient to consider only manufacturing tolerances when the shield member is cast in the case of mounting the shield member formed of the cast body on the connector member. In contrast, in the case of mounting a conventional shield member formed by combining two press-molded bodies on a connector member, both processing tolerances of members during press molding and assembling tolerances in assembling the two members need to be considered. Therefore, it is difficult to accurately mount the conventional shield member on the connector member.

<4> As one form of the communication cable with connector of <3> described above, a first guide portion for guiding a ground terminal into the shield member is provided at a position corresponding to the ground terminal, out of an opening of the shield member, and the ground terminal is an existing ground terminal provided on a circuit board to be connected to the connector member.

In electrically connecting the communication cable with connector of the embodiment to the circuit board, the shield member provided in the communication cable with connector is grounded. In the above configuration, since the first guide portion for receiving the ground terminal is provided in the opening of the shield member, the existing ground terminal provided on the circuit board can be directly utilized to ground the shield member. That is, the above configuration does not require a special configuration on the side of the circuit board in grounding the shield member provided in the communication cable with connector.

The communication cable with connector of <4> described above may be the following communication cable with connector.

In the communication cable with connector of <3> described above, a clearance is formed between an outer peripheral surface of the connector member and an inner peripheral surface of the shield member and an existing ground terminal provided on a circuit board is inserted into the clearance when the connector member is connected to the circuit board, the shield member includes an opening, a mating terminal corresponding to the first terminal being inserted into the opening, and a first guide portion provided at a position corresponding to the clearance on an inner peripheral edge of the opening, and the first guide portion is formed by gradually thinning the shield member toward the opening from an axially inner side of the shield member.

<5> As one form of the communication cable with connector of <4> described above, the connector member includes a second guide portion for curving the ground terminal inserted from the first guide portion into the shield member toward the shield member.

The ground terminal curved by the second guide portion is strongly pressed against the shield member. Thus, even if the connector member vibrates, electrical connection between the shield member and the ground terminal is easily ensured.

The communication cable with connector of <5> described above may be the following communication cable with connector.

In the communication cable with connector of <4> described above, the connector member includes a connector tube portion having an insertion hole, the first terminal being inserted into the insertion hole, and a second guide portion protruding on an outer periphery of the connector tube portion, and the second guide portion curves the ground terminal inserted from the first guide portion into the shield member toward the shield member.

<6> As one form of the communication cable with connector of any one of <3> to <5> described above, the shield member has no hole open in a peripheral surface thereof.

The shield member having no hole open in the peripheral surface is a shield member having no path of electromagnetic waves on a peripheral surface. Accordingly, the shield member having no hole in the peripheral surface can effectively suppress the superposition of noise on a communication signal flowing in the first terminal. Further, the shield member having no hole in the peripheral surface can effectively suppress the influence of electromagnetic waves radiated from the first terminal on another electrical device located near the connector member.

<7> As one form of the communication cable with connector of any one of <3> to <6> described above, a minimum value of a thickness of the shield member is 0.25 mm or more and 1.0 mm or less.

The shield member formed of the cast body tends to be thicker than a shield member formed of a pressed body. This is because the fillability of a molten material into a mold needs to be considered at the time of fabricating the shield member. If the minimum value of the thickness of the shield member is 0.25 mm or more, the fillability of the molten material at the time of fabricating the shield member is hardly deteriorated. If the minimum value of the thickness of the shield member is 1.0 mm or less, the enlargement of the shield member is suppressed.

<8> As one form of the communication cable with connector of any one of <3> to <7> described above, the shield member includes an accommodating portion, the conductive rubber member being arranged inside the accommodating portion, and the conductive rubber member is arranged inside the accommodating portion while being compressed.

In a configuration in which the conductive rubber member is press-fit in the accommodating portion of the shield member, electrical connection between the shield member and the conductive rubber member is reliably ensured. Therefore, the shielding layer of the communication cable is reliably grounded.

Further, the conductive rubber member press-fit into the accommodating portion of the shield member suppresses the intrusion of environmental water into the shield member.

<9> As one form of the communication cable with connector according to the embodiment, Ethernet (registered trademark) standards are satisfied.

The communication cable with connector satisfying the Ethernet (registered trademark) standards is suitable as a communication cable with connector, for example, installed in a vehicle. A communication volume of information tends to extremely increase regardless of wireless or wired in automotive vehicles of recent years.

<10> As one form of the communication cable with connector according to the embodiment, the first terminal includes an engaging claw, and the connector member includes an engaging recess to be locked to the engaging claw.

The first terminal is firmly fixed to the connector member by the engagement of the engaging claw and the engaging recess. Further, the configuration of the connector member is simplified by providing the engaging claw having a more complicated shape than the engaging recess on the first terminal. Thus, the connector member can be reduced in size.

<11> As one form of the communication cable with connector according to the embodiment, the communication cable is a twisted pair cable.

The twisted pair cable is a communication cable used in differential communication suitable for high-speed communication of data. The twisted pair cable is hardly affected by noise. Therefore, the twisted pair cable is suitable as a communication cable provided in the communication cable with connector of the embodiment used in high-speed communication of 100 Mbps or faster.

<12> A connector assembly according to the embodiment includes the communication cable with connector according to any one of <1> to <11> described above, a signal cable including an inner housing having a plurality of second terminals, and an outer housing for accommodating the connector member and the inner housing.

In the connector assembly in which the communication cable with connector and the signal cable are integrated by the outer housing, the number of connection of the connector to the circuit board is reduced. This is because a transmission route of the signal cable and a transmission route of the communication cable are constructed only by connecting the connector assembly of the embodiment to a connector assembly on the circuit board side.

<13> As one form of the connector assembly according to the embodiment, a total number of the first terminals and the second terminals is 20 or more and 200 or less.

If the total number of the first terminals and second terminals (poles) is 20 or more, many transmission routes can be constructed by one connection of the connector assembly. If the number of poles is 200 or less, connection resistance in connecting the connector assembly to a mating connector assembly does not become excessively high.

<14> As one form of the connector assembly according to the embodiment, a pitch of the second terminals is 0.1 mm or more and 2.0 mm or less.

If the pitch of the second terminals is in the above range, the connector assembly is easily reduced in size.

### DETAILS OF EMBODIMENTS OF PRESENT DISCLOSURE

Hereinafter, specific examples of a connector module, a communication cable with connector and a connector assembly according to embodiments of the present disclosure are described on the basis of the drawings. In figures, the same reference signs denote the same components. Note that the present invention is not limited to these illustrations and is intended to be represented by claims and include all changes in the scope of claims and in the meaning and scope of equivalents.

### First Embodiment

<<Communication Cable with Connector>>

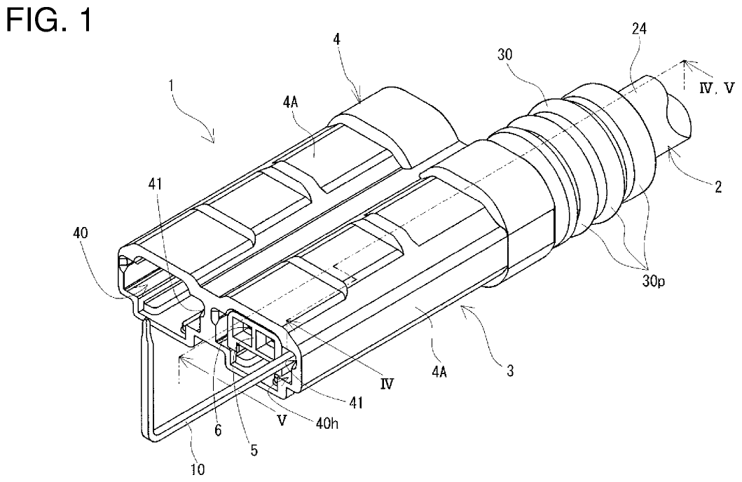

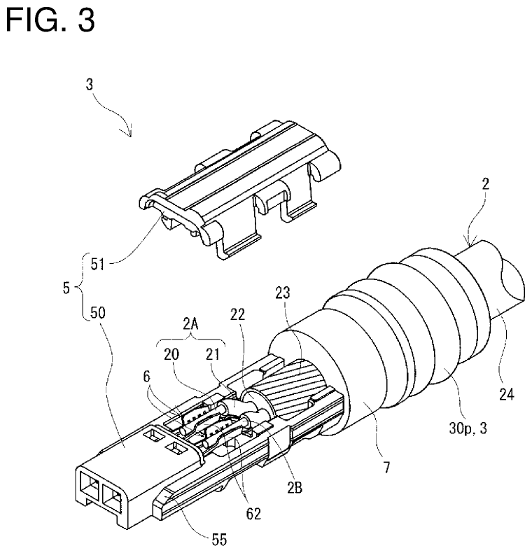

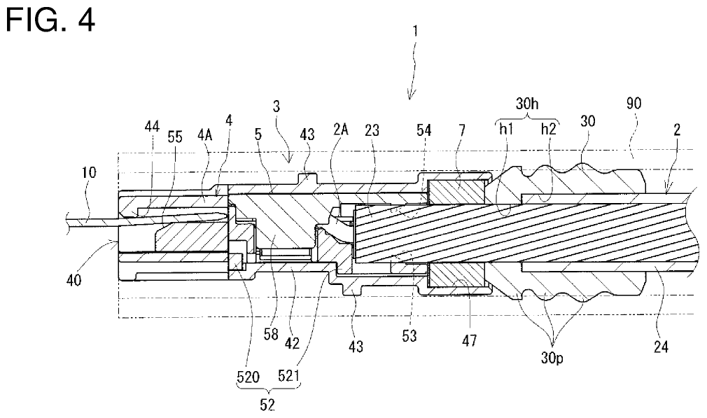

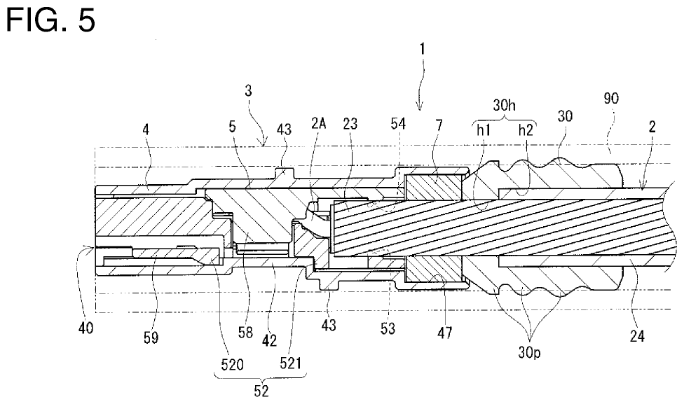

In this example, a communication cable with connector 1 used in wired high-speed communication in an automotive vehicle is described on the basis of FIGS. 1 to 14. Here, in FIGS. 1 and 4, a ground terminal 10 extending from a circuit board (not shown) of an in-vehicle device is shown in addition to the communication cable with connector 1. Although wire barrels 62 of first terminals 6 to be described later are shown in an open state in FIG. 3, the wire barrels 62 are actually in a closed state. A shielding layer 23 of a communication cable 2 is not shown in section in FIGS. 4 and 5. A vertical direction of FIGS. 1 to 5 does not necessarily coincide with a vertical direction in the automotive vehicle.

The communication cable with connector 1 of the embodiment shown in FIG. 1 includes the communication cable 2 used in communication of 100 Mbps or faster and a connector module 3 provided on an end part of the communication cable 2. This communication cable with connector 1 further includes a conductive rubber member 7 and a water stop plug 30 on the base end of the connector module 3. In this example, the communication cable with connector 1 is used in a state accommodated in an outer housing 90 shown by two-dot chain lines in FIGS. 4 and 5. Further, the communication cable with connector 1 of this example is a pigtail cable having the connector module 3 provided on one end of the communication cable 2. Unlike this example, the communication cable with connector 1 may be a jumper cable provided with the connector modules 3 on both ends of the communication cable 2.

As shown in FIGS. 1, 2, 4 and 5, the connector module 3 includes a connector member 5 and a tubular shield member 4 for covering the outer periphery of the connector member 5. As shown in FIG. 3, the connector member 5 includes the female terminals 6 inside. One of features of the communication cable with connector 1 and the connector module 3 of this example is that the shield member 4 is a cast body. Each component of the communication cable with connector 1 of this example is described in detail below.

<<Shield Member>>

Overall Configuration

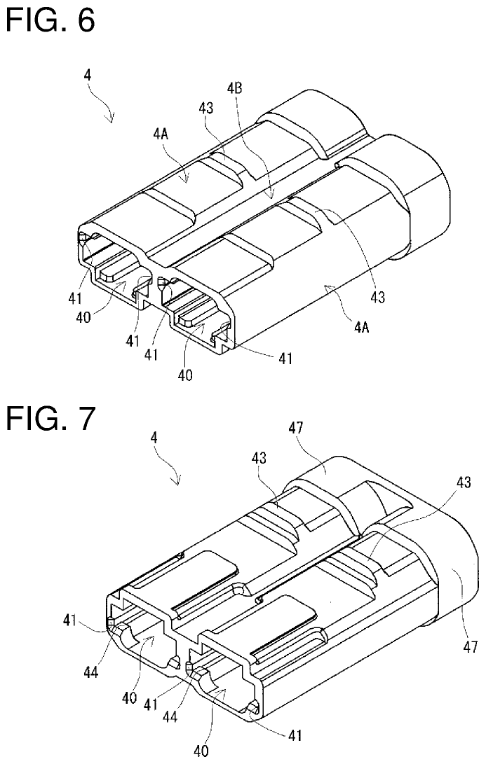

The shield member 4 is described mainly with reference to FIGS. 6 and 7. The shield member 4 is a member for shielding electromagnetic waves radiated from the female terminals 6 (FIG. 3) and conductors 20 (FIG. 3) and electromagnetic waves from outside the shield member 4. The shield member 4 has such a length that the entire connector member 5 can be accommodated inside. The shield member 4 is grounded by contacting the ground terminal 10 of FIG. 1. Thus, an induced current generated in the shield member 4 by electromagnetic waves is released to ground. Further, the shield member 4 is also electrically connected to the shielding layer 23 (FIG. 3) of the communication cable 2 (described in detail later). Therefore, an induced current generated in the shielding layer 23 is released to ground via the shield member 4.

The shield member 4 of this example is configured such that two tubular bodies 4A arranged in parallel are coupled into one body by a coupling portion 4B. Either of the two tubular bodies 4A has a continuous peripheral wall and has no hole penetrating through the inside and outside thereof. The both tubular bodies 4A and the coupling portion 4B are integrally molded. Although the connector member 5 is accommodated in one tubular body 4A in FIG. 1, one connector member 5 is actually accommodated in each tubular body 4A. That is, the shield member 4 of this example has a function of collecting two communication cables 2 into one and a function of collectively shielding electromagnetic waves in end parts of the two communication cables 2. Unlike this example, the shield member 4 may be composed of one tubular body 4A or three or more tubular bodies 4A.

When the communication cable with connector 1 of this example is connected to the unillustrated circuit board, unillustrated male terminals are inserted into openings 40 of the tubular bodies 4A. Since the female terminals 6 (FIG. 1, 2) in this example are female terminals, the male terminals are mating terminals corresponding to the female terminals.

As shown in FIG. 1, with the connector module 5 accommodated inside the tubular body 4A, a clearance 40h is formed between the inner peripheral surface of the shield member 4 and the outer peripheral surface of the connector member 5. The clearance 40h is formed outside the connector member 5 in an arrangement direction of two insertion holes 5h of the connector member 5. The existing ground terminal 10 provided on the circuit board is inserted into the clearance 40h when the connector member 5 is connected to the circuit board.

An axial length of the tubular body 4A is about 19 mm or more and 21 mm or less. On the other hand, a maximum outer diameter of the tubular body 4A is about 6.5 mm or more or 7 mm or less. That is, the size of the tubular body 4A is very smaller than that of a shielding structure called a shell in a power cable.

The shield member 4 of FIGS. 6 and 7 is a cast body fabricated by filling a molten alloy into a mold. More specifically, the shield member 4 of this example is a die-cast member obtained by injecting the molten alloy into the mold under pressure.

A material of the shield member 4 is not particularly limited as long as it is an alloy having a high electrical conductivity. However, the material of the shield member 4 is preferably a zinc alloy. The zinc alloy is an alloy in which a most contained element is zinc (Zn), out of elements constituting the alloy. For example, the zinc alloy is an alloy containing at least one element selected from a group composed of aluminum (Al), magnesium (Mg), iron (Fe), lead (pb), cadmium (Cd) and tin (Sn) besides zinc. In high-speed communication of 100 Mbps, the shield member 4 made of zinc alloy is better in shielding performance to shield electromagnetic waves than the shield member 4 made of aluminum alloy. Since the zinc alloy is excellent in electrical conductivity and strength, it is suitable as the material of the shield member 4. Further, since having a low viscosity, the molten zinc alloy easily spreads into narrow clearances of the mold. Therefore, the small-size and thin shield member 4 can be fabricated with good dimensional accuracy by using the zinc alloy. The zinc alloy is suitable as the material of the shield member 4 also because of its inexpensiveness.

Main Effects

The shield member 4 formed of the cast body can be so fabricated as to include no hole open in the peripheral surface thereof. Since the hole in the peripheral surface of the shield member 4 serves as a path of electromagnetic waves, this hole reduces the shielding performance of the shield member 4. The shield member 4 of this example has no hole serving as the path of electromagnetic waves in the peripheral surface thereof. Therefore, the connector module 3 of this example including the shield member 4 of this example is excellent in electromagnetic wave shielding performance. The communication cable with connector 1 of this example excellent in shielding performance is suitable for high-speed communication of 100 Mbps or faster.

The shield member 4 formed of the cast body can be easily assembled with the connector members 5. This is because the shield member 4 formed of the cast body needs not have a split structure. Thus, the connector module 3 and the communication cable with connector 1 including the shield member 4 of this example are excellent in productivity.

The shield member 4 formed of the cast body can be accurately mounted on the connector member 5. This is because it is sufficient to consider only manufacturing tolerances at the time of casting the shield member 4 in the case of mounting the shield member 4 formed of the cast body on the connector member 5. Unlike this example, it is difficult to accurately mount a conventional shield member described, for example, in Japanese Patent Laid-open Publication No. 2018-152174 or the like on a connector member. The conventional shield member is formed by combining two press-molded bodies. Thus, in the case of mounting the conventional shield member on the connector member, it is necessary to consider both processing tolerances of the members during press molding and assembling tolerances when the two members are combined. Because of these two tolerances, it is difficult to accurately mount the conventional shield member on the connector member.

Other Components

Shield-side engaging portions 42 to be engaged with the outer peripheries of the connector members 5 are provided inside the tubular shield member 4 (inside the tubular bodies 4A) (see FIGS. 4 and 5). The shield-side engaging portion 42 of this example is an engaging projection projecting from the inner peripheral surface of the shield member 4. This shield-side engaging portion 42 is engaged with a connector-side engaging portion 52 formed on the outer periphery of the connector member 5. Unlike this example, the shield-side engaging portion 42 may be an engaging recess.

The shield member 4 includes first guide portions 41 provided at positions corresponding to the clearances 40h on the inner peripheral edges of the openings 40. The first guide portion 41 is formed by gradually thinning the shield member 4 from an axially inner side of the tubular body 4A toward the opening 40. This first guide portion 41 is provided at a position corresponding to the ground terminal 10 (FIG. 1) in the opening 40, so that the ground terminal 10 is easily inserted into the tubular body 4A. By providing the first guide portion 41 in the opening 40, the existing ground terminal 10 provided on the circuit board of the in-vehicle device can be directly utilized to ground the shield member 4. Thus, a special design change on the side of the circuit board is not required in grounding the shield member 4 provided in the connector module 3.

A protruding portion 44 is provided near the first guide portion 41 in the opening 40. The protruding portion 44 is formed by the projecting inner peripheral surface of the tubular body 4A of the shield member 4. As shown in FIG. 4, the protruding portion 44 is provided on a surface facing a second guide portion 55 of the connector member 5 to be described later, out of the inner peripheral surface of the tubular body 4A. The protruding portion 44 is in contact with the outer peripheral surface of the ground terminal 10 curved by the second guide portion 55. That is, the protruding portion 44 serves as an electrical contact point between the shield member 4 and the ground terminal 10.

The shield member 4 formed of the cast body tends to be thicker than a shield member formed of a pressed body. This is because it is necessary to consider the fillability of the molten alloy into the mold at the time of fabricating the shield member 4. If the shield member 4 is thick, the size and mass of the shield member 4 may become large. In view of these points, a minimum value of the thickness of the shield member 4 (except at the positions of inclined surfaces of the first guide portions 41) is preferably 0.25 mm or more and 1.0 mm or less. A minimum distance between the inclined surface of the first guide portion 41 and the outer peripheral surface of the shield member 4 can be less than 0.25 mm. If the minimum value of the thickness of the shield member 4 is 0.25 mm or more, the fillability of the molten alloy at the time of fabricating the shield member 4 is hardly deteriorated. Moreover, sufficient strength of the shield member 4 is ensured. On the other hand, if the minimum value of the thickness of the shield member 4 is 1.0 mm or less, the enlargement and weight increase of the shield member 4 are suppressed. A more preferable minimum value of the thickness is 0.3 mm or more and 0.9 mm or less.

The shield member 4 preferably includes locally thickened thick portions 43. In this example, the thick portions 43 are formed on one surface side of the shield member 4 shown in FIG. 6 and the other surface side of the shield member 4 shown in FIG. 7. By providing the thick portions 43 on the shield member 4, the fillability of the molten alloy at the time of fabricating the shield member 4 is improved. Further, the strength of the shield member 4 is improved by the thick portions 43.

<<Communication Cable>>

The communication cable 2 shown in FIGS. 1 to 5 is not particularly limited as long as a communication speed of 100 Mbps or faster can be ensured. The communication speed of the communication cable 2 is preferably 1 Gbps or faster. The communication cable 2 of this example is a twisted pair cable satisfying Ethernet (registered trademark) standards. The twisted pair cable is suitable for differential communication less susceptible to noise.

The communication cable 2 (twisted pair cable) includes two wires 2A, 2B twisted as shown in FIG. 3. Each of the wires 2A, 2B includes the conductor 20 and a conductor insulation layer 21 for covering the outer periphery of the conductor 20. The two twisted wires 2A, 2B are gathered into one by an interposed insulation layer 22. The conductor insulation layers 21 and the interposed insulation layer 22 function as an insulation layer for ensuring the insulation of the conductors 20. The communication cable 2 further includes the shielding layer 23 provided on the outer periphery of the interposed insulation layer 22 and a sheath 24 for covering the shielding layer 23. The shielding layer 23 is for shielding electromagnetic waves and, for example, formed by a braided wire made of aluminum alloy. On the other hand, the sheath 24 is made of insulating resin such as polyvinyl chloride or polyethylene.

An end part of the communication cable 2 is stripped. The wires 2A, 2B are exposed from the interposed insulation layer 22 on a most tip side of the communication cable 2 and the conductors 20 are exposed from the conductor insulation layers 21 on the tips of the wires 2A, 2B. Further, the shielding layer 23 is exposed from the sheath 24 on an end part of the communication cable 2. A part of the shielding layer 23 exposed from the sheath 24 is exposed from a rear end part (end part on the side of the communication cable 2) of the shield member 4 as shown in sections of FIGS. 4 and 5. A part of the shielding layer 23 arranged inside the shield member 4 is electrically connected to the inner peripheral surface of the shield member 4 via the conductive rubber member 7 to be described later.

<<Connector Member>>

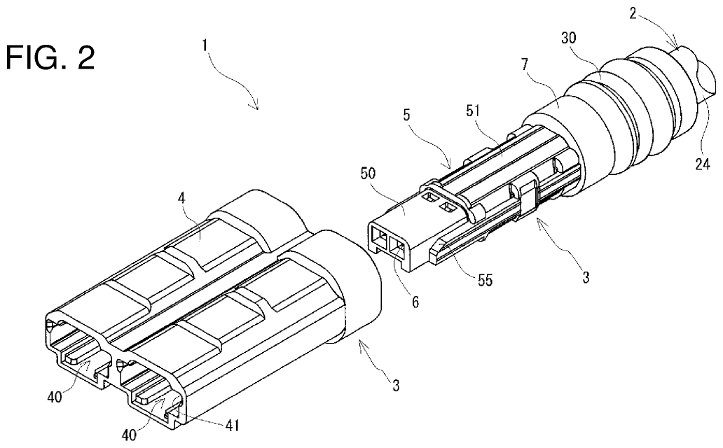

The connector member 5 of this example constituting the connector module 3 includes a housing 50 and a cover 51 as shown in FIGS. 2 and 3. The housing 50 and the cover 51 are both made of insulating resin such as polyethylene.

Housing

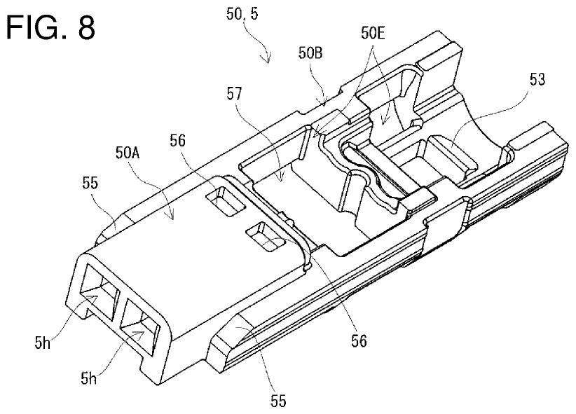

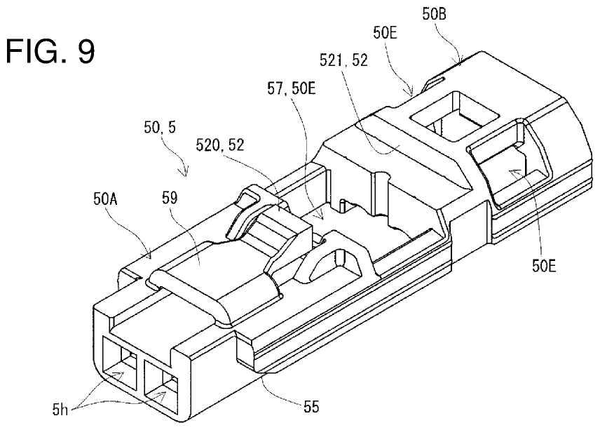

The housing 50 shown in FIGS. 8 and 9 includes a connector tube portion 50A into which the tips of the first terminals 6 shown in FIG. 3 are inserted, and a pedestal portion 50B supporting connected parts of the first terminals 6 and the conductors 20 from below. An upper side of the pedestal portion 50B is open.

The connector tube portion 50A includes a pair of insertion holes 5h into which the first terminals 6 (FIG. 3) are inserted. The connector tube portion 50A is provided with engaging recesses 56 (engaging holes) communicating with the insertion holes 5h from the outer peripheral surface thereof. The engaging recesses 56 may be recesses formed in the inner peripheral surfaces of the insertion holes 5h. An engaging claw 63 (FIG. 13) of the first terminal 6 to be described later is engaged with this engaging recess 56.

The pedestal portion 50B is provided with housing-side engaging portions 50E and a through hole 57. The housing-side engaging portions 50E are used to couple the housing 50 and the cover 51. The housing-side engaging portions 50E of this example are formed by engaging holes penetrating through the pedestal portion 50B. On the other hand, the through hole 57 is provided at a position corresponding to the connected parts of the first terminals 6 and the conductors 20 shown in FIG. 3. The through hole 57 is provided to facilitate a connecting operation of the first terminals 6 and the conductors 20. That is, the communication cable 2 can be connected later to the first terminals 6 accommodated in the housing 50. If the first terminals 6 accommodated in the housing 50 can be handled, the first terminals 6 can be transported and connected to the communication cable 2 without being damaged. This through hole 57 doubles as the housing-side engaging portion 50E. Unlike this example, the housing-side engaging portions 50E may be engaging claws.

Cover

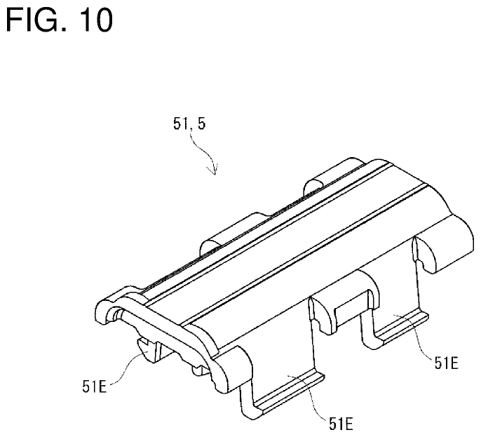

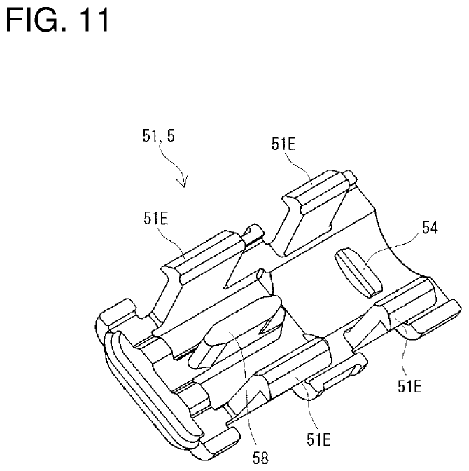

The cover 51 shown in FIGS. 10 and 11 is a member for covering openings of the pedestal portion 50B in the housing 50 shown in FIG. 8. The cover 51 is provided with a plurality of cover-side engaging portions 51E. The cover-side engaging portions 51E of this example are engaging claws to be fit into the housing-side engaging portions 50F formed by the engaging holes. By the engagement of the engaging claws and the engaging holes, the cover 51 is firmly fixed to the housing 50. Here, if the housing-side engaging portions 50E are formed by engaging claws, the cover-side engaging portions 51E may be engaging holes.

As shown in FIG. 11, the cover 51 includes a partitioning portion 58 projecting from the inner peripheral surface thereof. This partitioning portion 58 is interposed between a pair of the connected parts (connected parts of the conductors 20 and the wire barrels 62) arranged in parallel in FIG. 3. Insulation between the connected parts arranged in parallel is ensured by the partitioning portion 58.

Configuration for Fixing Communication Cable to Connector Member

As shown in FIGS. 4 and 5, the connector member 5 of this example includes clamp portions 53, 54 inside. A pair of the clamp portions 53, 54 are provided at positions separated in a circumferential direction of the communication cable 2. As shown in FIG. 8, the clamp portion 53 is provided on the inner peripheral surface of the pedestal portion 50B of the housing 50. More specifically, the clamp portion 53 is provided at a position corresponding to the shielding layer 23 (FIGS. 4 and 5) on a bottom part of the pedestal portion 50B. The clamp portion 53 of this example is a wide claw-like member long in a width direction of the housing 50. A projection amount of the clamp portion 53 increases toward the connector tube portion 50A. Therefore, the clamp portion 53 has a substantially right triangular shape in a side view.

One the other hand, as shown in FIG. 11, the clamp portion 54 is provided on the inner peripheral surface of the cover 51. More specifically, the clamp portion 54 is at a position facing the clamp portion 53 (FIG. 8) on a body part (part except the cover-side engaging portions 51E) of the cover 51. The clamp portion 54 of this example is a wide claw-like member having substantially the same width as the clamp portion 53. A projection amount of the clamp portion 54 decreases after increasing toward the partitioning portion 58. An angle of inclination of a surface of the clamp portion 54 on the side of the partitioning portion 58 is larger than that of a surface on an opposite side (surface on the side of the communication cable 2). Therefore, the clamp portion 54 has a substantially scalene triangular shape in a side view.

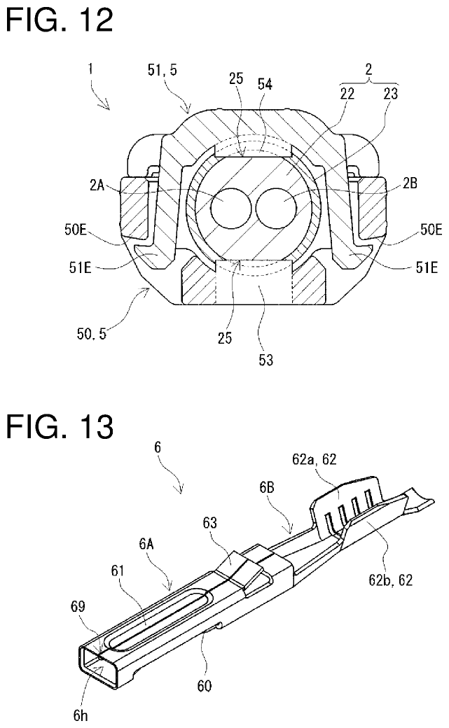

As shown in FIG. 12, the clamp portions 53, 54 bite into the interposed insulation layer 22 via the shielding layer 23 from the outer periphery of the shielding layer 23 of the communication cable 2. In this example, the interposed insulation layer 22 is provided with cut portions 25 corresponding to the clamp portions 53, 54 in advance. The clamp portions 53, 54 bite into the cut portions 25 to push and widen the cut portions 25. Unlike this example, the clamp portions 53, 54 may bite into the interposed insulation layer 22 by pressing the outer periphery of the interposed insulation layer 22 when the housing 50 and the cover 51 are engaged. In either case, the connector member 5 is certainly fixed to the end part of the communication cable 2 by the clamp portions 53, 54. Even if the shielding layer 23 is deformed by the clamp portions 53, 54, the shielding performance of the communication cable with connector 1 is not reduced. This is because the outer periphery of the connector member 5 is covered by the shield member 4 quite excellent in shielding performance in the communication cable with connector 1 of this example.

Here, in a conventional communication cable with connector, a communication cable and a connector member are engaged by a crimp ring made of metal (see, for example, Japanese Patent Laid-open Publication No. 2017-126408, etc.). More specifically, the crimp ring is mounted on the outer periphery of a sheath of the communication cable. A part of the crimp ring protrudes radially outwardly of the ring. This protruding part is fit into a cut groove formed in the connector member, whereby the communication cable and the connector member are engaged. However, in a configuration using the crimp ring, the connector member tends to be long. This is because the connector member has to have such a length capable of enclosing the crimp ring gripping the sheath. For example, in the case of providing a crimp ring for the connector member 5 according to this embodiment, a length of the connector member 5 is about 23 mm.

As compared to the conventional connector member using the crimp ring, the connector member 5 of this example is short. This is because the clamp portions 53, 54 grip a part of the communication cable 2 having the sheath 24 stripped therefrom in the connector member 5 of this example. In the configuration for gripping the communication cable 2 by the clamp portions 53, 54, the length of the connector member 5 can be 22 mm or less. If the connector member 5 is made shorter, the shield member 4 for covering the connector member 5 can also be made shorter. Thus, the connector module 3 is considerably reduced in weight. A more preferable length of the connector member 5 is 20 mm or less. A lower limit value of the length of the connector member 5 is about 10 mm.

Configuration for Assisting Contact of Ground Terminal and Shield Member

As shown in FIG. 8, the connector member 5 includes second guide portions 55 lateral to the insertion holes 5h. The second guide portions 55 are provided at positions along an extending direction of the ground terminal 10 when the shield member 4 of FIG. 2 is viewed from front from the side of the opening 40. The second guide portion 55 has an inclined surface inclined downward toward a tip side (left side in FIG. 8) of the connector member 5. Thus, as shown in FIG. 4, the ground terminal 10 inserted into the shield member 4 is curved toward the shield member 4 (upward in FIG. 4) along the inclined surface of the second guide portion 55. An intermediate part in a length direction of the curved ground terminal 10 contacts the protruding portion 44 provided on the side of the opening 40 of the shield member 4. Since the curved ground terminal 10 tries to return to a straight state, the intermediate part of the ground terminal 10 is strongly pressed against the protruding portion 44. Thus, even if the connector module 3 vibrates according to the vibration of the automotive vehicle, electrical connection of the shield member 4 and the ground terminal 10 is easily secured.

Fixing of Connector Member to Shield Member

As shown in FIG. 5, the connector member 5 is fixed inside the shield member 4. The connector-side engaging portion 52 is used for this fixation. The connector-side engaging portion 52 is engaged with the shield-side engaging portion 42 of the shield member 4, whereby the connector member 5 is firmly fixed inside the shield member 4.

As shown in FIG. 9, the connector-side engaging portion 52 of this example is provided on the outer peripheral surface of the housing 50. More specifically, the connector-side engaging portion 52 is composed of a resilient projection 520 provided on the connector tube portion 50A and a step portion 521 provided on the pedestal portion 50B. The resilient projection 520 is cantilevered and supported on a rear end part (end part on the side of the pedestal portion 50B) of an arched portion 59 provided on the outer peripheral surface of the connector tube portion 50A. A surface of the resilient projection 520 on a tip side (left side in FIG. 9) of the connector member 5 is an inclined surface. Further, a surface of the resilient projection 520 on a base end side (right side in FIG. 9) of the connector member 5 is a vertical surface. On the other hand, the step portion 521 is formed by locally thickening the pedestal portion 50B. A surface of the step portion 521 on the tip side of the connector member 5 is a vertical surface.

The connector member 5 is inserted into the shield member 4 from a base end side (side of an accommodating portion 47) (see FIG. 5). As the connector member 5 is inserted into the shield member 4, the resilient projection 520 contacts the shield-side engaging portion 42 and is deformed upward in FIG. 5. When the connector member 5 is further inserted into the shield member 4, the step portion 521 of the connector member 5 is stopped in contact with the shield-side engaging portion 42, whereby the insertion of the connector member 5 into the shield member 4 is completed. At this time, the resilient projection 520 rides over the shield-side engaging portion 42 and returns to an original shape. As a result, the shield-side engaging portion 42 is sandwiched between the resilient projection 520 and the step portion 521 (state shown in FIG. 5). Since the resilient projection 520 and the step portion 521 are stopped in contact, the connector member 5 does not come out from the shield member 4.

<<First Terminals>>

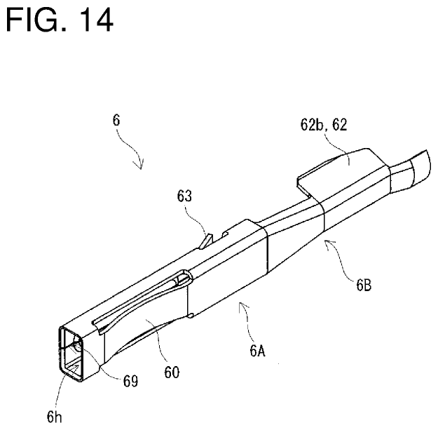

The first terminals 6 to be accommodated into the connector member 5 may be female terminal or male terminals. The first terminals 6 of this example are female terminals. The first terminals 6 are described mainly with reference to FIGS. 13 and 14.

The first terminal 6 is fabricated by press-molding one plate material. The plate material before being pressed has a bilaterally symmetrical shape. The first terminal 6 includes a tubular portion 6A and a connecting portion 6B. The tubular portion 6A includes a terminal hole 6h, into which an unillustrated male terminal is inserted. By the mechanical contact of the first terminal (female terminal) 6 and the male terminal, the female terminal 6 and the male terminal are electrically connected.

The tubular portion 6A includes a leaf spring portion 60 for pressing the outer peripheral surface of the male terminal inserted into the terminal hole 6h. An outer part of this leaf spring portion 60 is exposed on the outer periphery of the tubular portion 6A. As shown in FIG. 14, the leaf spring portion 60 is constituted by a part of the tubular portion 6A. Specifically, a part of the lower surface (surface facing forward in FIG. 14) of the tubular portion 6A in the form of a rectangular tube constitutes the leaf spring portion 60. An end part of the leaf spring portion 60 on the side of the terminal hole 6h and an end part of the leaf spring portion 60 on the side of the connecting portion 6B are linked to the tubular portion 6A. On the other hand, two corner parts of the tubular portion 6A on opposite sides of the leaf spring portion 60 are punched out. A central part of the leaf spring portion 60 in an axial direction (direction along which the male terminal is inserted and withdrawn) of the tubular portion 6A is curved inwardly of the tubular portion 6A. Such a leaf spring portion 60 is easily fabricated by press-molding. For example, the leaf spring portion 60 is formed only by punching out some of parts serving as corner parts of the tubular portion 6A, out of the plate material from which the first terminal 6 is formed, and fabricating the tubular portion 6A by press-molding.

If one plate material having a bilaterally symmetrically shape is press-molded, a seam 69 at which edge parts of the plate material are butted against each other is arranged in a center of a surface of the tubular portion 6A opposite to the leaf spring portion 60. The seam 69 extends along an axial direction of the terminal hole 6h. The first terminal 6 is bilaterally symmetrically shaped with respect to the seam 69. An overlapping part of the plate material is not present in the first terminal 6 of this example. Since conductivity nonuniformity hardly occurs in the bilaterally symmetric first terminal 6, loss of a transmission signal is reduced. Therefore, the transmission characteristic of the communication cable with connector 1 provided with the first terminals 6 is improved.

In the small-size first terminal 6 as used in a communication cable, the seam 69 is normally not arranged on the surface of the tubular portion 6A into which the male terminal is inserted. This is because the seam 69 arranged on the surface of the tubular portion 6A means that the end faces of the plate material of the first terminal 6 are butted against each other and the seam 69 may be opened due to the springback of the pressed plate material. On the other hand, in this example, the first terminal 6 is inserted into the insertion hole 5h of the connector member 5 almost without any clearance and the outer periphery of the first terminal 6 is surrounded by the connector member 5 as shown in FIG. 2. Thus, there is no risk that the seam 69 of the first terminal 6 is opened. Therefore, in this example, an improvement in the transmission characteristic of the first terminal 6 is prioritized and the seam 69 is set on the surface of the tubular portion 6A on purpose.

A pressing portion 61 concave toward the inside of the tubular portion 6A is provided on a surface of the tubular portion 6A opposite to the leaf spring portion 60. The pressing portion 61 presses the male terminal accommodated into the tubular portion 6A toward the leaf spring portion 60. As a result, the contact of the male terminal and the leaf spring portion 60 is reliably ensured. The pressing portion 61 of this example is also exposed on the outer periphery of the tubular portion 6A. Since nothing covers the pressing portion 61 from outside, the pressing portion 61 can be simultaneously formed when the tubular portion 6A is press-molded.

The connecting portion 6B is a part to be electrically connected to the conductor 20 (FIG. 3). This connecting portion 6B is provided with the wire barrel 62. The wire barrel 62 is a member for gripping the conductor 20. Left and right wing-like portions 62a, 62b constituting the wire barrel 62 are symmetrically shaped. Here, the first terminal 6 of this example includes only the wire barrel 62 as a barrel for gripping the outer periphery of the communication cable 2. A conventional terminal includes an insulation barrel for gripping the sheath 24 of the communication cable 2, but the first terminal 6 of this example includes no insulation barrel.

The first terminal 6 includes the engaging claw 63 to be engaged with the engaging recess 56 of the connector member 5 (FIG. 8). The engaging claw 63 is formed by forming a cut in a part of the plate material constituting the first terminal 6 and bending the part formed with the cut. Thus, the engaging claw 63 acts like a leaf spring. The tip of the engaging claw 63 is facing toward the wire barrel 62. The first terminal 6 is inserted into the insertion hole 5h of the connector member 5 from the side of the pedestal portion 50B of FIG. 8. When the first terminal 6 is inserted into the insertion hole 5h, the engaging claw 63 is deformed toward the inside of the tubular portion 6A. The engaging claw 63 returns to an original shape by the resilience thereof at a position corresponding to the engaging recess 56 (FIG. 8). The engaging claw 63 is hooked to the engaging recess 56 and the first terminal 6 is firmly fixed to the connector member 5.

The first terminal 6 used in the communication cable 2 is very small in size. For example, an axial length of the first terminal 6 is about 10 mm or more and 15 mm or less. Further, lengths of long sides of the terminal hole 6h of the first terminal 6 are about 0.9 mm or more and 1.1 mm or less and lengths of short sides thereof are about 0.4 mm or more and 0.6 mm or less.

A thickness of each part of the first terminal 6 is preferably 0.15 mm or less. As already described, each part of the shield member 4 formed of the cast body tends to be thicker than a shield member formed of a pressed body. To avoid the enlargement of the shield member 4, the connector member 5 and the first terminals 6 to be arranged inside the shield member 4 are preferably reduced in size. If the thickness of each part of the first terminal 6 is 0.15 mm or less, the first terminal 6 is easily reduced in size.

The thickness of each part of the first terminal 6 is preferably 0.05 mm or more. If this thickness is 0.05 mm or more, the strength of the first terminal 6 is ensured. A more preferable thickness of each part of the first terminal 6 is 0.075 mm or more and 0.13 mm or less. An even more preferable thickness of each part of the first terminal 6 is 0.080 mm or more and 0.10 mm or less. The thickness mentioned here does not include a thickness of an edge formed by bending the plate material constituting the first terminal 6.

The first terminal 6 is made of the material excellent in conductivity. Here, the first terminal 6 includes no protecting portion for covering the outer periphery of the leaf spring portion 60 unlike conventional female terminals. Thus, the first terminal 6 of this example is preferably made of a material excellent in strength. An example of the material excellent in conductivity and strength is stainless steel. Stainless steels preferable for the first terminal 6 of this example are, for example, 1.4372, 1.4373, 1.4310, 1.4318, 1.4305, 1.4307, 1.4306, 1.4311, 1.4303, 1.4401, 1.4436, 1.4404, 1.4432, 1.4435, 1.4406, 1.4429, 1.4571, 1.4438, 1.4434, 1.4439, 1.4539, 1.4541, 1.4550, 1.4587, 1.4381, 1.4462, 1.4507 and 1.4002 in European standards. Among these, 1.4310 and 1.4318 are, for example, preferable in terms of conductivity and strength. The surface of the first terminal 6 is preferably plated with a material excellent in conductivity. A plating material is, for example, tin (Sn) or silver (Ag).

The first terminal 60 configured as described above has a very simple configuration. Particularly, since the first terminal 6 has no configuration for covering the leaf spring portion 60 and the pressing portion 61 from outside, the leaf spring portion 60 and the pressing portion 61 can be simultaneously fabricated when the tubular portion 6A is press-molded. Therefore, the first terminal 6 of this example can be more easily fabricated than conventional female terminals.

The first terminal 6 is preferably handled in a state accommodated in the housing 50 of the connector member 5. In this case, the first terminal 6 is protected by the housing 50. Therefore, the first terminal 6 is hardly damaged even if the first terminal 6 is very small in size and thin.

<<Conductive Rubber Member>>

The communication cable with connector 1 of this example includes the tubular conductive rubber member 7 arranged on the outer periphery of the shielding layer 23 exposed from the sheath 24 in the end part of the communication cable 2 as shown in FIGS. 4 and 5. The conductive rubber member 7 is made of a material obtained by blending conductive carbon black or metal powder into one of various rubber materials such as natural rubbers and synthetic rubbers. This conductive rubber member 7 is in contact with the inner peripheral surface of the accommodating portion 47 in the shield member 4. That is, the shielding layer 23, in which an induced current flows, and the shield member 4 to be grounded are electrically connected by the conductive rubber member 7. Therefore, the induced current flowing in the shielding layer 23 can be released to ground by the conductive rubber member 7.

Due to resilience, the conductive rubber member 7 is easily arranged on the outer periphery of the shielding layer 23. This is because the conductive rubber member 7 can be arranged on the outer periphery of the shielding layer 23 only by fitting the conductive rubber member 7 expanded in diameter to the communication cable 2. Thus, the communication cable with connector 1 using the conductive rubber member 7 is excellent in productivity. Further, due to resilience, the conductive rubber member 7 is easily held in close contact with the outer periphery of the shielding layer 23. Therefore, in the communication cable with connector 1 using the conductive rubber member 7, electrical connection between the shielding layer 23 and the shield member 4 is reliably ensured.

The conductive rubber member 7 is press-fit into the accommodating portion 47 provided in a rear end part (end part on the side of the communication cable 2) of the shield member 4. The conductive rubber member 7 presses the accommodating portion 47 from inside and is held in close contact with the accommodating portion 47. Thus, the shielding layer 23 is reliably grounded. Further, the conductive rubber member 7 press-fit into the accommodating portion 47 functions as a water stop plug for suppressing the intrusion of environmental water into the shield member 4.

The conductive rubber member 7 of this example does not entirely cover the shielding layer 23. A part of the shielding layer 23 not covered by the conductive rubber member 7 is arranged inside the water stop plug 30. Unlike this example, this conductive rubber member 7 may have such a length as to reach the outer periphery of the sheath 24 in the axial direction of the communication cable 2. For example, the conductive rubber member 7 and the water stop plug 30 to be described later are integrated. In that case, the number of components constituting the communication cable with connector 1 is reduced, wherefore the productivity of the communication cable with connector 1 is improved.

<<Water Stop Plug>>

The water stop plug 30 shown in FIGS. 4 and 5 is a tubular member for suppressing the exposure of the shielding layer 23 to environmental water (including moisture in the air). The water stop plug 30 of this example prevents water intrusion into a clearance between the inner peripheral surface of the insertion hole, into which the connector module 3 is inserted, in the outer housing 90 and the sheath 24 of the communication cable 2. That is, the water stop plug 30 suppresses the arrival of the environmental water from a side closer to the communication cable 2 than the water stop plug 30 at the shielding layer 23 through a clearance between the inner peripheral surface of the water stop plug 30 and the outer peripheral surface of the sheath 24. Further, the water stop plug 30 suppresses the arrival of the environmental water at the shield member 4 through a clearance between the outer peripheral surface of the water stop plug 30 and the inner peripheral surface of the insertion hole of the outer housing 90. An axial length of this water stop plug 30 is about 8 mm or more and 10 mm or less.

The water stop plug 30 is provided near the conductive rubber member 7, more specifically at a position in contact with a rear end part (end part on the side of the communication cable 2) of the conductive rubber member 7. This water stop plug 30 includes a cable hole 30h through which the communication cable 2 is inserted. The cable hole 30h includes a small-diameter portion h1 and a large-diameter portion h2 having a larger diameter than the small-diameter portion h1. That is, the cable hole 30h of the water stop plug 30 is formed with a step before the water stop plug 30 is mounted on the communication cable 2, i.e. before the water stop plug 30 is expanded in diameter. The small-diameter portion h1 is arranged on the side of the connector member 5, and the large-diameter portion h2 is arranged on the side of the communication cable 2. The inner peripheral surface of the small-diameter portion h1 is in close contact with the shielding layer 23, and the inner peripheral surface of the large-diameter portion h2 is in close contact with the sheath 24. Thus, at a location of the communication cable 2 where the sheath 24 is striped, the cable hole 30h of the water stop plug 30 and the outer peripheral surface of the communication cable 2 are in close contact with each other without any clearance. An end surface of the sheath 24 is hooked to the step between the small-diameter portion h1 and the large-diameter portion h2. That is, the water stop plug 30 of this example is structured to be directly mounted on the communication cable 2. The water stop plug 30 thus structured does not separately require a holder for fixing the water stop plug 30 at a desired position. Therefore, the productivity of the communication cable with connector 1 including cost and assembling efficiency is improved.

A plurality of annular projections 30p projecting radially outwardly of the water stop plug 30 are provided on the outer peripheral surface of the water stop plug 30. The plurality of annular projections 30p are arranged in an axial direction of the water stop plug 30. The annular projections 30p are deformed when the water stop plug 30 is pushed into the insertion hole of the outer housing 90, thereby facilitating the pushing of the water stop plug 30. Further, since the annular projections 30p are expanded radially outwardly to be held in close contact with the inner peripheral surface of the insertion hole after the water stop plug 30 is pushed into the insertion hole, water intrusion into a clearance between the inner peripheral surface of the insertion hole and the outer peripheral surface of the water stop plug 30 is firmly prevented.

The tip of the water stop plug 30 on the side of the connector member 5 presses the conductive rubber member 7. The tip surface of the water stop plug 30 is in close contact with the rear end surface of the conductive rubber member 7. Therefore, the intrusion of environmental water to the shielding layer 23 from a boundary between the water stop plug 30 and the conductive rubber member 7 is effectively suppressed.

In the water stop plug 30 having the step in the cable hole 30h, the entire water stop plug 30 needs not be expanded in diameter to the size of a part having a large outer diameter in the step shape of the communication cable 2. Thus, even in the case of fitting the very small water stop plug 30 to the thin communication cable 2, the water stop plug 30 needs not be expanded in diameter more than necessary. Therefore, the water stop plug 30 is easily fit on the outer periphery of the communication cable 2.

Further, since the cable hole 30h of the water stop plug 30 has the step, the step of the water stop plug 30 is stopped in contact with the end surface of the sheath 24 of the communication cable 2 when the water stop plug 30 is fit to the communication cable 2. Therefore, the water stop plug 30 is properly arranged at the desired position on the communication cable 2. Since the step of the water stop plug 30 is hooked to the end surface of the sheath 24, the water stop plug 30 on the communication cable 2 is hardly shifted in position by an external force or the like.

<First Modification>

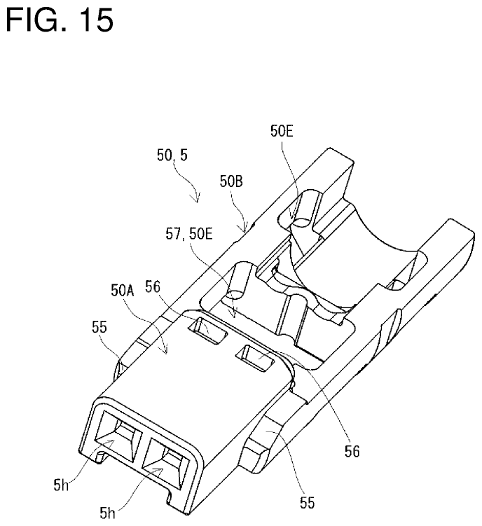

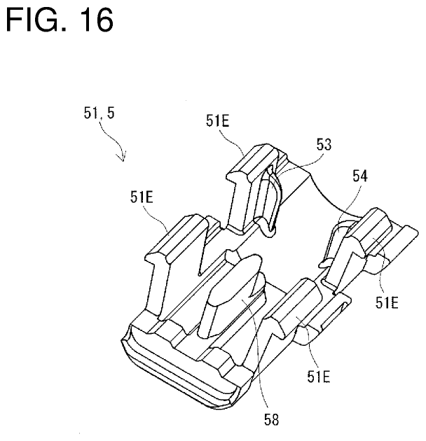

A communication cable with connector 1 provided with a connector member 5 different from the first embodiment in the configurations of clamp portions 53, 54 is described on the basis of FIGS. 15 to 17. FIG. 15 is a perspective view of a housing 50 of the connector member 5 viewed from an inner peripheral side, and FIG. 16 is a perspective view of a cover 51 viewed from an inner peripheral side.

As shown in FIG. 15, the housing 50 of this example includes no clamp portion on the inner peripheral surface of a pedestal portion 50B. On the other hand, as shown in FIG. 16, the cover 51 of this example includes a pair of clamp portions 53, 54 on the inner peripheral surface thereof. The clamp portions 53, 54 are provided at positions separated in a width direction of the cover 51. More specifically, the clamp portion 53 is provided on the inner peripheral surface of one of a pair of cover-side engaging portions 51E on a rear end side of the cover 51 and the clamp portion 54 is provided on the inner peripheral surface of the other cover-side engaging portion 51E. The clamp portions 53, 54 are curved plate-like members convex toward a side opposite to a partitioning portion 58. Thus, the tips of the clamp portions 53, 54 are arranged closer to the partitioning portion 58 (closer to the first terminals 6 of FIG. 3) than base ends thereof. Further, the clamp portions 53, 54 become thinner toward the tips from the base ends thereof. The both clamp portions 53, 54 are also integrally linked to a body portion of the cover 51. Therefore, the clamp portions 53, 54 also function as reinforcing members for the cover-side engaging portions 51E.

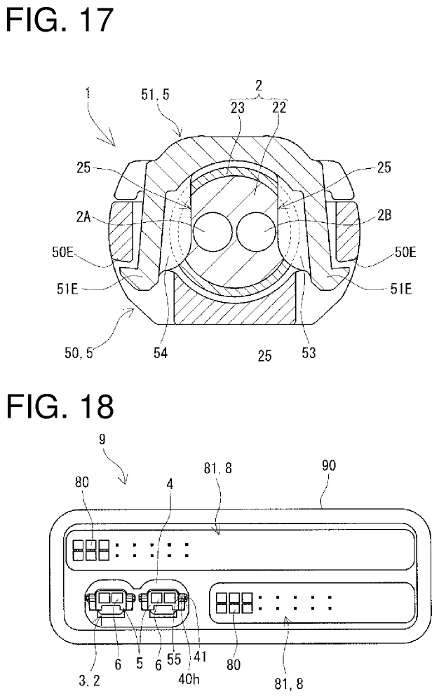

As shown in FIG. 17, in the communication cable with connector 1 using the connector member 5 of this example, the clamp portions 53, 54 provided in the cover 51 sandwich the communication cable 2 from outer peripheral sides. At that time, the clamp portions 53, 54 bite into cut portions 25 provided in the interposed insulation layer 22. Also by this configuration, the connector member 5 can be firmly fixed to an end part of the communication cable 2.

### Second Embodiment

A connector assembly 9 provided with the communication cable with connector 1 of the first embodiment is described on the basis of FIG. 18.

FIG. 18 is a schematic front view of the connector assembly 9 viewed from a side where terminals 6, 80 are exposed. The connector assembly 9 of this example includes the communication cable with connector 1 of the first embodiment, a signal cable 8 and an outer housing 90.

The signal cable 8 is a cable for transmitting an electrical signal and includes an inner housing 81 on an end part thereof. The inner housing 81 includes a plurality of second terminals 80. Since the first terminals 6 are female terminals, the second terminals 80 of this example are female terminals. If the first terminals 6 are male terminals, the second terminals 80 are also male terminals. On the other hand, the outer housing 90 is a member for collectively accommodating the connector module 3 of the communication cable with connector 1 and the inner housing 81 of the signal cable 8.

The connector assembly 9 provided with the communication cable with connector 1 facilitates the construction of a communication environment in an automotive vehicle. If this connector assembly 9 is connected to a male connector assembly (not shown) provided on a circuit board of an in-vehicle device, a transmission route of the signal cable and a transmission route of the communication cable are simultaneously constructed.

A total number of the first terminals 6 and the second terminals 80 (poles) is preferably 20 or more and 200 or less. If the number of poles is 20 or more, many transmission routes can be constructed by one connection of the connector assembly 9. If the number of poles is 200 or less, connection resistance in connecting the female connector assembly 9 of this example to a male connector assembly does not become excessively high.

A pitch of the second terminals 80 is preferably 0.1 mm or more and 2.0 mm or less. If the pitch of the second terminals 80 is in the above range, the connector assembly 9 is easily reduced in size. If the connector assembly 9 can be reduced in size, the connector assembly 9 of a size corresponding to a male connector assembly to be provided on a circuit board is easily fabricated.

### LIST OF REFERENCE NUMERALS

1 communication cable with connector
2 communication cable
   2A, 2B wire
   20 conductor, 21 conductor insulation layer, 22 interposed insulation layer,
   23 shielding layer, 24 sheath, 25 cut portion
3 connector module
   30 water stop plug, 30h cable hole, h1 small-diameter portion,
   h2 large-diameter portion, 30p annular projection
4 shield member
   4A tubular portion, 4B coupling portion
   40 opening, 41 first guide portion, 42 shield-side engaging portion,
   43 thick portion, 44 protruding portion, 47 accommodating portion
   40h clearance
5 connector member
   5h insertion hole
   50 housing
   50A connector tube portion, 50B pedestal portion,
   50E housing-side engaging portion
   51 cover, 51E cover-side engaging portion
   52 connector-side engaging portion, 520 resilient projection, 521 step portion
   53, 54 clamp portion, 55 second guide portion
   56 engaging recess, 57 through hole, 58 partitioning portion,
   59 arched portion
6 first terminal
   6A tubular portion, 6B connecting portion, 6h terminal hole
   60 leaf spring portion, 61 pressing portion, 62 wire barrel, 63 engaging claw,
   69 seam
   62a, 62b wing-like portion
7 conductive rubber member
8 signal cable
   80 second terminal, 81 inner housing
9 connector assembly
   90 outer housing
10 ground terminal

1. A communication cable with connector used in communication of 100 Mbps or faster, comprising:
a first terminal;
a connector member made of resin for accommodating the first terminal;
a tubular shield member for covering an outer periphery of the connector member;
a communication cable including a conductor to be electrically connected to the first terminal, a shielding layer arranged on an outer peripheral side of the conductor and a sheath for covering an outer periphery of the shielding layer,
a tubular conductive rubber member for electrically connecting the shielding layer exposed from the sheath in an end part of the communication cable and the shield member, and
a tubular water stop plug provided near the conductive rubber member,
wherein:
the water stop plug includes a cable hole, the communication cable being inserted through the cable hole, and a plurality of annular projections projecting radially outward from an outer peripheral surface of the water stop plug,
the cable hole includes a small-diameter portion to be held in close contact with the shielding layer and a large-diameter portion to be held in close contact with the sheath,
an end surface of the sheath is caught by a step between the small-diameter portion and the large-diameter portion, and
one of the plurality of annular projections is at a position corresponding to the step in an axial direction of the water stop plug.

2. The communication cable with connector according to claim 1, wherein the shield member is a cast body having no hole open in a peripheral surface thereof.

3. A communication cable with connector used in communication of 100 Mbps or faster, comprising:
a first terminal;
a connector member made of resin for accommodating the first terminal;
a tubular shield member for covering an outer periphery of the connector member;
a communication cable including a conductor to be electrically connected to the first terminal, a shielding layer arranged on an outer peripheral side of the conductor and a sheath for covering an outer periphery of the shielding layer,
a tubular conductive rubber member for electrically connecting the shielding layer exposed from the sheath in an end part of the communication cable and the shield member, and
a tubular water stop plug provided near the conductive rubber member,
wherein:
the water stop plug includes a cable hole, the communication cable being inserted through the cable hole, the cable hole including a small-diameter portion to be held in close contact with the shielding layer and a large-diameter portion to be held in close contact with the sheath,
an end surface of the sheath is caught by a step between the small-diameter portion and the large-diameter portion, and
the shield member is a cast body having no hole open in a peripheral surface thereof.

4. The communication cable with connector according to claim 3, wherein:
a plurality of annular projections projecting radially outward are provided on an outer peripheral surface of the water stop plug, and
the plurality of annular projections are arranged in an axial direction of the communication cable.

5. The communication cable with connector according to claim 1, wherein the conductive rubber member and the water stop plug are integrated.

6. The communication cable with connector according to claim 1, comprising a clearance formed between an outer peripheral surface of the connector member and an inner peripheral surface of the shield member, an existing ground terminal provided on a circuit board being inserted into the clearance when the connector member is connected to the circuit board,
wherein:
the shield member includes:
an opening into a mating terminal corresponding to the first terminal is inserted; and
a first guide portion provided at a position corresponding to the clearance on an inner peripheral edge of the opening, and
the first guide portion is formed by gradually thinning the shield member toward the opening from an axially inner side of the shield member.

7. The communication cable with connector according to claim 6, wherein:
the connector member includes:
a connector tube portion having an insertion hole, the first terminal being inserted into the insertion hole; and
a second guide portion protruding on an outer periphery of the connector tube portion, and
the second guide portion curves the ground terminal inserted from the first guide portion into the shield member toward the shield member.

8. The communication cable with connector according to claim 1, wherein a minimum value of a thickness of the shield member is 0.25 mm or more and 1.0 mm or less.

9. The communication cable with connector according to claim 1, wherein:
the shield member includes an accommodating portion, the conductive rubber member being arranged inside the accommodating portion, and
the conductive rubber member is arranged inside the accommodating portion while being compressed.

10. The communication cable with connector according to claim 1, wherein Ethernet (registered trademark) standards are satisfied.

11. The communication cable with connector according to claim 1, wherein:
the first terminal includes an engaging claw, and
the connector member includes an engaging recess to be locked to the engaging claw.

12. The communication cable with connector according to claim 1, wherein the communication cable is a twisted pair cable.

13. A connector assembly, comprising:
the communication cable with connector according to claim 1;
a signal cable including an inner housing having a plurality of second terminals, and
an outer housing for accommodating the connector member and the inner housing.

14. The connector assembly according to claim 13, wherein a total number of the first terminals and the second terminals is 20 or more and 200 or less.

15. The connector assembly according to claim 13, wherein a pitch of the second terminals is 0.1 mm or more and 2.0 mm or less.
